(19) United States
(12) Patent Application Publication
(10) Pub. No.: US 2025/0183817 A1
(43) Pub. Date: Jun. 5, 2025

(54) FRICTION MATERIAL, VIBRATION TYPE ACTUATOR, OPTICAL DEVICE, ELECTRONIC DEVICE, AND MANUFACTURING METHOD OF FRICTION MATERIAL

(71) Applicant: CANON KABUSHIKI KAISHA, Tokyo (JP)

(72) Inventor: SHINGO EGUCHI, Kanagawa (JP)

(21) Appl. No.: 18/968,763

(22) Filed: Dec. 4, 2024

(30) Foreign Application Priority Data
Dec. 5, 2023 (JP) 2023-205717

(51) Int. Cl. H02N 2/04; B22F 3/12; B22F 3/24; C23C 8/26; H02N 2/12

(52) U.S. Cl. CPC H02N 2/04; B22F 3/12; C23C 8/26; H02N 2/12; B22F 2003/242; B22F 2301/35

(57) ABSTRACT

A friction material includes a stainless steel group sintered body having pores. The stainless steel group sintered body includes a nitride layer and an interior portion, the nitride layer containing iron nitride and being present on a surface of the stainless steel group sintered body, the interior portion being present in an inner part of the stainless steel group sintered body. The interior portion includes an austenite phase and a martensite phase, a content of the austenite phase in the interior portion being 75 vol % or more and 99 vol % or less, and a Vickers hardness of the interior portion is 300 HV0.1 or more and 600 HV0.1 or less.

### BACKGROUND

### Technical Field

The present disclosure relates to a friction material, a vibration type actuator, an optical device, an electronic device, and a manufacturing method of the friction material.

### Description of the Related Art

A vibration type actuator which makes a vibration body and a contact body relatively move has been known. The vibration type actuator pressurizes the vibration body having an electric-mechanical energy conversion element and the contact body to bring the vibration body and the contact body into contact, and makes the vibration body and the contact body relatively move by making the vibration body excite predetermined vibration to apply frictional driving force to the contact body from the vibration body. The vibration body consists of a piezoelectric body and an elastic body joined to the piezoelectric body, and transmits vibration generated by applying voltage to the piezoelectric body to the contact body via the elastic body. As described above, driving force of the vibration type actuator depends on frictional force exerted on the elastic body and the contact body, and thus the contact body needs to have a function as a friction material. On the other hand, when the vibration type actuator is left under a high-humidity environment, the surfaces of the elastic body and the contact body may adsorb moisture to cause the frictional force to be lowered.

Further, in a typical vibration type actuator, the above-described elastic body has a protruding portion, and a leading end of the protruding portion is in contact with the contact body. Since frictional force occurs between the elastic body and the contact body, a surface of the contact body is gradually abraded while being driven. In order to maintain breaking performance, it is desirable to prevent formation of a deep abrasion mark on the surface of the contact body. Thus, there is a need for a contact body having high abrasion resistance, which can be used for a purpose that requires a high degree of breaking accuracy.

Japanese Patent Application Laid-Open No. 2017-225333 discusses a technique in which a stainless steel sintered body impregnated with resin is used as a contact body. According to the technique discussed in Japanese Patent Application Laid-Open No. 2017-225333, a quenched martensitic stainless steel material and an austenitic stainless steel material having a nitride layer on its surface are used as the stainless steel sintered bodies.

In a case where long-term use of a contact body is a prerequisite, or in a case where a vibration body and a contact body are brought into contact at considerably high pressure, a contact body having higher abrasion resistance is desired.

### SUMMARY

A aspect of the present disclosure is to provide a friction material having high abrasion resistance, capable of maintaining frictional force even under a high-humidity environment. Another aspect of the present disclosure is to provide a vibration type actuator, an optical device, and an electronic device, that include friction materials having high abrasion resistance, capable of maintaining frictional force even under the high-humidity environment. Yet another aspect of the present disclosure is to provide a manufacturing method of a friction material having high abrasion resistance, capable of maintaining frictional force even under the high-humidity environment.

The above-described aspect is achieved by the present disclosure described below. According to an aspect of the present disclosure, a friction material includes a stainless steel group sintered body having pores. The stainless steel group sintered body includes a nitride layer and an interior portion, the nitride layer containing iron nitride and being present on a surface of the stainless steel group sintered body, the interior portion being present in an inner part of the stainless steel group sintered body. The interior portion includes an austenite phase and a martensite phase, a content of the austenite phase in the interior portion being 75 vol % or more and 99 vol % or less, and Vickers hardness of the interior portion is 300 HV0.1 or more and 600 HV0.1 or less.

According to another aspect of the present disclosure, a friction material that includes a stainless steel group sintered body having pores. The stainless steel group sintered body includes a nitride layer and an interior portion, the nitride layer containing iron nitride, which is present on a surface of the stainless steel group sintered body, the interior portion being present in an inner part of the stainless steel group sintered body. The interior portion contains an austenite phase and a martensite phase, a content of the austenite phase in the interior portion being 1.0 vol % or more and 25 vol % or less, and Vickers hardness of the interior portion is 300 HV0.1 or more and 600 HV0.1 or less.

According to still another aspect of the present disclosure, a manufacturing method of a friction material, the manufacturing method includes acquiring, after the raw-material powder is pressurized and molded, a stainless steel group sintered body by sintering raw-material powder containing stainless steel powder, and executing a nitriding treatment process for forming a nitride layer on a surface of the stainless steel group sintered body. The stainless steel group sintered body has a nitride layer and an interior portion, the nitride layer containing iron nitride and being present on a surface of the stainless steel group sintered body, the interior portion being present in an inner part of the stainless steel group sintered body. The interior portion includes an austenite phase and a martensite phase, a content of the austenite phase in the interior portion being 75 vol % or more and 99 vol % or less, and Vickers hardness of the interior portion is 300 HV0.1 or more and 600 HV0.1 or less.

According to still yet another aspect of the present disclosure, a manufacturing method of a friction material includes acquiring, after the raw-material powder is pressurized and molded, a stainless steel group sintered body by sintering raw-material powder containing stainless steel powder, and executing a nitriding treatment process for forming a nitride layer on a surface of the stainless steel group sintered body. The stainless steel group sintered body has a nitride layer and an interior portion, the nitride layer containing iron nitride and being present on a surface of the stainless steel group sintered body, the interior portion being present in an inner part of the stainless steel group sintered body. The interior portion includes an austenite phase and a martensite phase, a content of the martensite phase in the interior portion being 1.0 vol % or more and 25 vol % or less, and Vickers hardness of the interior portion is 300 HV0.1 or more and 600 HV0.1 or less.

Further features of the present disclosure will become apparent from the following description of exemplary embodiments with reference to the attached drawings.

### BRIEF DESCRIPTION OF THE DRAWINGS

FIG. 1 is a schematic diagram illustrating a surface of a friction material according to a first exemplary embodiment.

FIG. 2 is an illustrative diagram illustrating a cross-sectional view of the friction material according to the first exemplary embodiment.

FIG. 3 is a schematic diagram illustrating a vibration type actuator according to the first exemplary embodiment.

FIG. 4 is a schematic diagram illustrating an evaluation apparatus for evaluating surface layer destruction strength used for Examples and Comparison examples.

FIG. 5 is a schematic diagram illustrating a frictional force testing apparatus used for the Examples and Comparison examples.

FIG. 6 is a schematic diagram illustrating an optical device according to a second exemplary embodiment.

FIG. 7 is a schematic diagram illustrating an electronic device according to the second exemplary embodiment.

### DESCRIPTION OF THE EMBODIMENTS

The inventors conducted a study on a manufacturing method of a friction material which maintains the frictional force even under a high-humidity environment.

In the course of our study, it was found that Vickers hardness of the martensitic material described in Japanese Patent Application Laid-Open No. 2017-225333 remained within a range of 600 HV to 800 HV at the highest. In other words, it was found that the abrasion resistance acquired by the conventional friction material was not sufficient for an extremely long-term use or for a driving operation executed in a state where a vibration body and a driven body were brought into contact with high pressure force.

On the other hand, with respect to the austenitic material on which a nitride layer was formed, described in Japanese Patent Application Laid-Open No. 2017-225333, the surface hardness was sufficiently high, such as 1000 HV or more. However, hardness of the interior portion where the nitride layer was not formed was significantly low. Thus, it was found that a surface defect caused by contact between components or contact with a shipping container or a treatment jig easily occurred in the course of various treatment processes and conveyance processes.

As a result of further study, it was found that an abrasion amount substantially increased in a case where the austenite phase was small and hardness was excessively high. It was thought that the above phenomenon was caused by local destruction on the surface which became brittle because of formation of a nitride layer. As a result of our study, it was found that enhancing the toughness of the interior portion was important because it was necessary to prevent the above-described destruction in order to ensure the abrasion resistance of the friction material.

Based on the above-described standpoint, it was found that the abrasion resistance of the friction material could be improved by making the content of the austenite phase having the toughness be a certain value or more, and by making the hardness be a certain value or less. Specifically, a friction material having high abrasion resistance can be provided by making the content of the austenite phase in the interior portion be 75 vol % or more and 99 vol % or less, and by making the Vickers hardness of the interior portion be 300 HV0.1 or more and 600 HV0.1 or less.

Hereinafter, the present disclosure will be described in detail with preferred exemplary embodiments.

### (Sintering Process)

First, a manufacturing process of a sintered body serving as a base material of the friction material will be described. In order to improve the corrosion resistance under the high-humidity environment, it is preferable that stainless steel powder containing 10.5 wt % or more chromium (Cr) be used as a raw material of the sintered body for the friction material according to the first exemplary embodiment. In other words, it is preferable that a stainless steel group sintered body be used as a sintered body. It is also preferable that a content of chromium in the stainless steel sintered body be 16 wt % or less.

As described above, a surface defect occurs in a sintered body consisting of only an austenite phase because the sintered body has a low degree of hardness. Thus, it is preferable that martensitic stainless steel powder be selected as a raw material of the sintered body. In order to appropriately control the ratio between the martensite phase and the austenite phase contained in the sintered body, processing conditions of the sintering process and the thermal treatment process described below have to be selected appropriately.

In order to adjust the hardness, mixed powder, i.e., a mixture of carbon powder and stainless steel powder, may be used as the raw material of the sintered body. However, in a case where the carbon powder is mixed excessively, separated carbon powder produces a lubricating effect to cause frictional force to be lowered. Thus, an upper limit of the additive amount of carbon powder is 2 wt %.

A molding tool (mold) having a desired shape is prepared depending on a purpose, and the molding tool is filled with raw-material powder. Then, a molded body is manufactured by pressurizing and molding the raw-material powder. A sintered body is manufactured by sintering the acquired molded body for a predetermined period at a predetermined temperature.

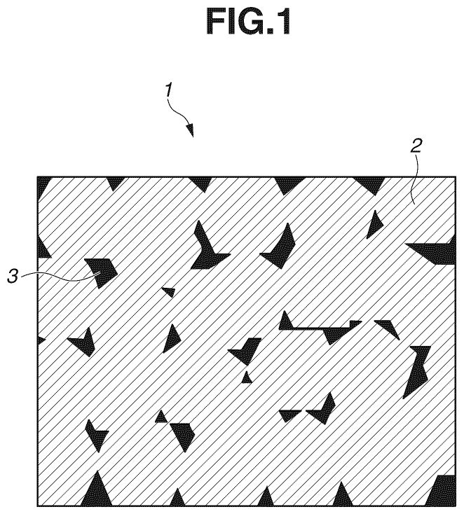

FIG. 1 is a schematic diagram illustrating a surface of the friction material according to the present exemplary embodiment. A friction material 1 has gaps remaining as pores 3, which are generated when stainless steel raw-material particles 2 join together. Through an impregnation process described below, part of the pores 3 may be impregnated with resin as necessary. In order to ensure the abrasion resistance, it is preferable that a volume ratio of the pores 3 to the stainless steel sintered body, i.e., porosity rate of the stainless steel sintered body, be 15% or less. In order to improve the frictional force under the high-humidity environment, it is preferable that the porosity rate be 3% or more.

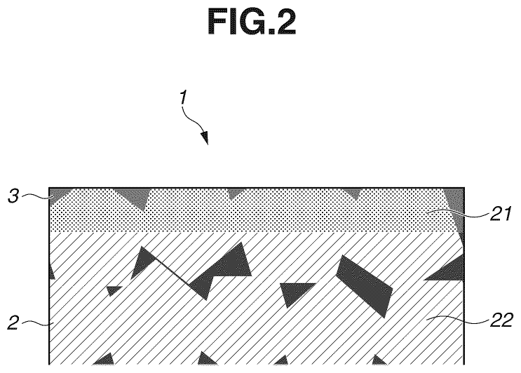

FIG. 2 is an illustrative diagram illustrating a cross-sectional view of the friction material according to the first exemplary embodiment. The friction material 1 has a nitride layer 21 containing nitride (iron nitride) located on the surface and the interior portion 22 located on the inner side of the nitride layer 21. FIG. 2 does not illustrate the entire friction material according to the present exemplary embodiment, and part of the friction material is omitted.

Composition and mechanical/physical properties of the sintered body have a great influence on composition and mechanical/physical properties of the interior portion of a finished product acquired after execution of the nitriding treatment described below. and such composition and mechanical/physical properties of the sintered body are directly related to the effect of the present disclosure. Factors, such as an amount of carbon powder to be mixed, a sintering temperature, and a cooling speed, in the course of the sintering process to the manufacturing process, have a great influence on the volume ratio or hardness of the martensite phase and the austenite phase contained in the generated sintered body.

In order to acquire a sintered body containing a martensite phase and an austenite phase with a volume ratio within a preferred range described below, the above-described factors are selected appropriately.

Specifically, it is preferable that the sintering process be executed at a sintering temperature of 1150° C. or more, in a case where manufacturing of the sintered body is completed by only the sintering process for sintering a molded body without executing post-processes, such as a thermal treatment and a sub-zero treatment.

In order to control the hardness or the toughness more precisely, a post-treatment may be executed after the sintering process. Specifically, after the sintering process, it is preferable that a thermal treatment be executed at a thermal treatment temperature of 1150° C. or more after a sub-zero treatment is executed for 1 minute or more at a temperature of minus 100° C. or less. As another example, after the sintering process, it is preferable that the sub-zero treatment be executed for less than 1 minute at a temperature of minus 100° C. or less without executing the thermal treatment thereafter.

In order to control the porosity rate within a preferred range, it is also preferable that the sintering process and the thermal treatment be executed at a temperature of 130° C. or less. In the sintering process, the porosity rate of the sintered body can also be adjusted by a molding pressure or a sintering temperature. Methods, such as an Archimedes method, a gas displacement method, and a method for calculating the porosity rate from a size and a weight, are effective for evaluating the porosity rate.

### (Nitriding Treatment Process)

Next, a nitriding treatment will be described. The nitriding treatment method employed in the present exemplary embodiment is not limited, and the nitriding treatment method can be any of typically-used methods, i.e., an ion nitriding treatment, a radical nitriding treatment, a gas nitriding treatment, a gas soft nitriding treatment, and a salt bath nitriding treatment. In particular, a comparatively thick nitride layer can be formed by the ion nitriding treatment. This treatment is effective in a case where part of a surface layer is removed by a final polishing process described below. It is possible to form a nitride layer having a desired thickness and hardness by controlling the temperature and the treatment time through any of the above-described nitriding treatment. The thickness and the hardness of the nitride layer also depend on the material to be selected, and thus it is desirable that an appropriate treatment condition be acquired experimentally.

The nitride layer formed by the nitriding treatment contains iron nitride. As the iron nitride, the nitride layer includes at least any one of an ε phase (Fe₂₋₃N) and a γ′ phase (Fe₄N), or a mixed phase of the ε phase (Fe₂₋₃N) and the γ′ phase (Fe₄N).

Specifically, it is preferable that Vickers hardness of the nitride layer be 1000 HV0.1 or more, and a thickness of the nitride layer in the finished friction material be 1.0 μm (micrometers) or more. In a case where surface grinding or surface polishing is to be executed as a post-process, it is desirable that a target thickness of the nitride layer acquired by the nitriding treatment be determined with consideration for an amount of the nitride layer removed by the post-process.

In a case where flatness is required for a component, it is preferable that the nitriding treatment be executed after the flatness is ensured by a grinding or polishing process for eliminating warpage or distortion arising after the sintering process.

This is because a removal amount of the nitride layer is increased if the flattening process is executed after the nitriding treatment, so that the process time for ensuring the final nitride layer thickness becomes long. As described above, it is possible to select a minimum amount of process time by executing the nitriding treatment after the flattening process.

### (Resin Impregnation Process)

Next, a resin impregnation process will be described. The frictional force under the high-humidity environment can be enhanced by using the sintered body as a base material, however, the frictional force can be further enhanced by impregnating the pores with resin. Based on the above-described standpoint, it is possible to acquire the friction material having higher frictional force under the high-humidity environment, although the resin impregnation is not necessarily required. For example, a typical vacuum impregnation treatment can be employed for the resin impregnation process.

For example, the vacuum impregnation treatment is executed through the following procedures. One or a plurality of sintered bodies is placed in a vacuum chamber, and the air and adsorbed moisture within the pores formed on the sintered bodies are removed by vacuuming the internal space of the vacuum chamber to the atmospheric pressure or lower. Thereafter, resinous materials used as impregnating materials are put into the vacuum chamber. Various resinous materials, such as acrylic, epoxy, silicone, phenolic, and polyester resinous materials are used as the resinous materials to be impregnated. Ingredients are adjusted as appropriate in order to make the resinous materials have low viscosity at a room temperature so that the resinous materials can be impregnated easily.

In order to facilitate the impregnation further inward, the vacuum chamber is opened after the internal space thereof is pressurized to the atmospheric pressure or higher, and the sintered body is heated after the resinous materials remaining on the surface of the sintered body is removed by being centrifugated or wiped. In this way, the impregnated resinous materials are hardened. Although an appropriate heating method is employed depending on the selected resinous materials, it is possible to employ a simple method in which a sintered body is immersed in hot water having a temperature greater than or equal to 80° C., or a sintered body is put into an oven and heated at a desired temperature. As described above, a large amount of resinous materials can be impregnated further inward by using the vacuum chamber. The resin impregnation process according to the present exemplary embodiment is not limited to the above. For example, a method may be used in which, after an appropriate amount of impregnating resinous materials are applied to a friction face, viscosity of the resinous materials is lowered by heating the resinous materials, and then the resinous materials is impregnated by the force of gravity.

### (Final Polishing Process)

In a case where the sintered body is used for a purpose, such as a driven body of a vibration type actuator, which requires a high degree of breaking performance, the sintered body can be polished in order to reduce the surface roughness of the sliding face. Examples of a polishing method include a fixed abrasive polishing method, a loose abrasive polishing method, and a barrel polishing method. However, in a case where abrasive grains are too large, a large cycle of polishing mark is formed on a surface, so that the pores formed by the sintering process are collapsed, and the impregnated resinous materials are prevented from being exposed to the surface. In this case, an effect on the aspect of the present disclosure cannot be acquired sufficiently. It is thus necessary to be careful when the polishing process is to be executed. The post-process is not necessarily required in a case where the surface roughness does not have to be reduced for the purpose of use.

### (Characteristics of Friction Material)

On a surface of the friction material manufactured through the above processes, a nitride layer is formed. On an inner part of the friction material, an interior portion is formed so as to be adjacent to the nitride layer. The nitride layer includes, as the iron nitride, at least any one of an ε phase (Fe₂₋₃N) and a γ′ phase (Fe₄N), or a mixed phase of the ε phase (Fe₂₋₃N) and the γ′ phase (Fe₄N).

The interior portion contains an austenite phase and a martensite phase. It is preferable that a content of the austenite phase in the interior portion be 75 vol % or more and 99 vol % or less, and more preferably, the content be 75 vol % or more and 97 vol % or less. In other words, it is preferable that the content of the martensite phase in the interior portion be 1.0 vol % or more and 25 vol % or less, and more preferably, the content be 3.0 vol % or more and 25 vol % or less. Further, it is preferable that Vickers hardness of the interior portion be 300 HV0.1 or more and 600 HV0.1 or less, and more preferably, Vickers hardness be 390 HV0.1 or more and 580 HV0.1 or less.

By enhancing the hardness of the interior portion by reducing the content of the austenite phase, it is possible to suppress occurrence of the above-described surface defect caused by collision between components. On the other hand, it was found that an abrasion amount was substantially increased in a case where a content of the austenite phase was small and the hardness was excessively high. It was thought that the above-described phenomenon was caused by local destruction on the surface which became brittle because of formation of a nitride layer.

As a result of the earnest study, it was found that enhancing the toughness of the interior portion was important because it was necessary to prevent the above-described destruction in order to ensure the abrasion resistance of the friction material. Based on the above-described standpoint, in order to improve the abrasion resistance of the friction material, a sintered body has to contain the austenite phase having toughness at a certain rate or more, and the hardness of the sintered body has to be a certain value or less.

The sintering process or the thermal process executed after the sintering process mainly becomes important in order to control the composition and the hardness of the interior portion. Depending on a case, however, compositional change caused by a tempering effect occurs in the sintered body because the sintered body is also exposed to a thermal environment of a temperature exceeding 400° C. Based on the above-described standpoint, it is desirable to manufacture a sintering body which does not make major compositional change even if the nitriding treatment is executed thereon. In this way, the interior portion directly inherits a content of the austenite phase and hardness acquired by the sintering treatment or the thermal treatment. In a case where the change caused by the nitriding treatment is not avoidable, a content of the austenite phase and hardness which should be acquired at the time of sintering are determined from a trend of the change, so that the effect of the present disclosure can similarly be acquired.

### (Analysis of Friction Material)

Quantitative evaluation of a crystal phase can be executed through a method using magnetic induction such as a ferrite meter. Through the above method, it is possible to measure a volume ratio of the martensite phase as an electromagnetic material to the sample. In a case where the crystal phase that is generated after the sintering process or the heating treatment consists of only the austenite phase and the martensite phase, a content other than the measured martensite phase can be evaluated as the content of the austenite phase.

On the other hand, in a case where a carbide phase is also contained, a content of the carbide phase has to be evaluated separately. In this case, it is effective to employ a methods, such as a quantification method employing X-ray diffraction, and a method which quantifies a carbide phase present in an observed image through image processing, by analyzing a cross-sectional view of the sample through an electronic microscope, to which an energy dispersive X-ray analysis device (EDX) is attached. It is also necessary to acquire a content of the martensite phase contained in a net stainless steel material excluding the pores because the sintered material contains many pores. For example, it is assumed that a measured value acquired through a magnetic induction method is 40%, and a total porosity rate of the sintered body is 10%. In this case, a content of the martensite phase based on 90%, which excludes the pores, i.e., 44.4% (=40/90), is the content of the martensite phase to be acquired. In a case where the sample consists of only the austenite phase and the martensite phase, 55.6% (=100%-44.4%) is the content of the austenite phase to be evaluated.

In a case where the interior portion is to be evaluated after the nitride layer is formed, the sample is fractured, and a thickness of the nitride layer is determined from the fractured face. Then, evaluation is executed after the nitride layer formed on the surface of the sample is removed by polishing. In this way, it is possible to execute precise evaluation. However, in a case where the nitride layer is extremely thin in comparison to the thickness of the sample, it is not necessary to make the above-described arrangement. In other words, through a method using magnetic induction, an inner part of the sample can be evaluated because a depth as a measurement target is large. Thus, in a case where a ratio of the thickness of the nitride layer to the thickness of the sample is small and equivalent to measurement deviations, a content of the austenite phase in the interior portion can be acquired without any problem by measuring the sample including the nitride layer.

The hardness can be measured by using a micro Vickers hardness tester available on the market. It is desirable to evaluate the sintered sample by selecting an area where pores are not present. Hardness of the surface corresponding to the nitride layer can be acquired by measuring the surface of the sample, and hardness of the interior portion is acquired by measuring a fractured face of the fractured sample or by measuring the surface after the nitride layer is removed by polishing.

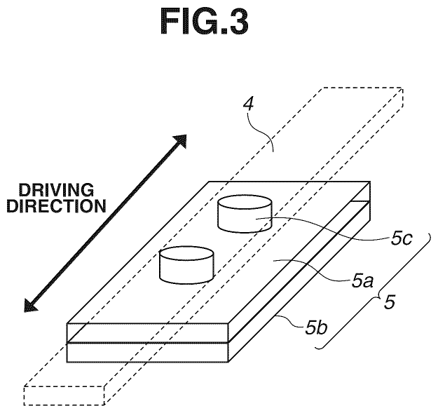

The friction material acquired through the above-described method can be used as a contact body of the vibration type actuator illustrated in FIG. 3. A vibration body 5 includes a substantially rectangular-shaped flat plate-like elastic body 5a as a base material, and a substantially flat plate-like piezoelectric element 5b as one example of the electric-mechanical energy conversion element, which is bonded to one of the faces of the elastic body 5a with adhesive. The elastic body 5a has two protruding portions 5c arranged on a face opposite to the face bonded to the piezoelectric element 5b, and leading ends of the protruding portions 5c are in contact with the contact face of the contact body 4.

The contact body 4 is pressurized against and brought into contact with the vibration body 5 by a pressurizing unit (not illustrated). By applying voltage to the piezoelectric element 5b, the protruding portions 5c generate elliptic motion, so that the contact body 4 and the vibration body 5 can relatively move in a driving direction indicated by an arrow in FIG. 3. By using the friction material according to the present exemplary embodiment as a contact body, it is possible to acquire a vibration type actuator having high driving thrust force and high abrasion resistance even under the high-humidity environment.

Next, an imaging apparatus and an industrial robot will be described as examples of an optical device and an electronic device employing the vibration type actuators using the above-described contact body 4.

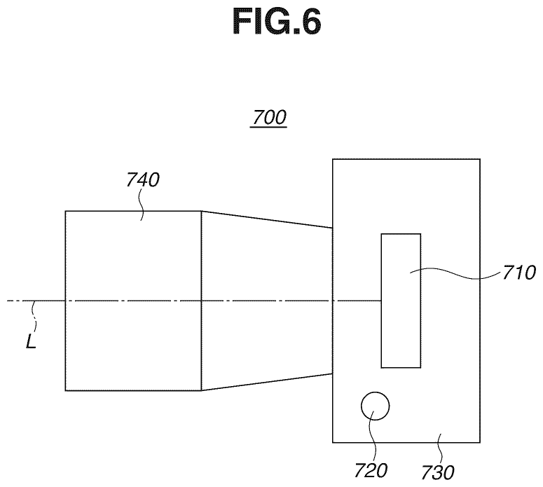

FIG. 6 is a top plan view illustrating a schematic configuration of an imaging apparatus (device) 700 as one example of the optical device. The imaging apparatus 700 includes a camera main body 730 on which an image sensor 710 and a power button 720 are mounted. The imaging apparatus 700 also includes a lens barrel 740 including a lens group and a vibration type actuator which are not illustrated. The lens group as an example of the optical element is driven by the vibration type actuator. The lens barrel 740 is an interchangeable lens capable of being replaced with others, so that the lens barrel 740 appropriate for an imaging target can be attached to the camera main body 730.

The vibration type actuator described with reference to FIG. 3 can be used as the vibration type actuator. Although it is thought to be that driving of a lens executed by the vibration type actuator is preferable for driving an autofocus lens, the exemplary embodiment is not limited thereto, and a zoom lens can similarly be driven by the vibration type actuator. The vibration type actuator can be used for driving an image sensor, and can also be used for driving a lens or an image sensor when a camera shake is to be corrected.

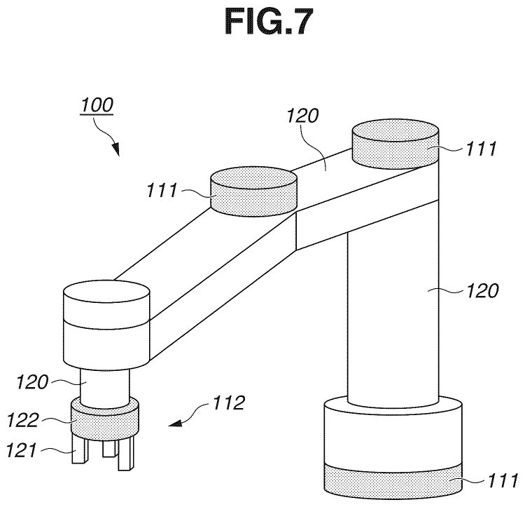

FIG. 7 is a perspective diagram illustrating a schematic configuration of a robot (device) 100 as one example of an electronic device on which a vibration type actuator is mounted. In here, a horizontal articulated robot is illustrated as one type of industrial robot.

The robot 100 includes members such as arm joint units 111 and a hand unit 112. Each of the arm joint units 111 connects two arms 120 to enable the two arms 120 to change an angle of intersection. The hand unit 112 includes an arm 120, a grip unit 121 attached to one end of the arm 120, and a hand joint unit 122 which connects the arm 120 and the grip unit 121. The vibration type actuators are built into the arm joint units 111 and the grip unit 121, and causes the arms 120 and the hand joint unit 122 to adjust the angles and to perform rotary movement.

The vibration type actuator with low rotation frequency at high torque, having a TN characteristic (i.e., a drooping characteristic indicating a relationship between the load torque and the rotational frequency), is preferably used for bending the arm joint unit 111 or making the hand unit 112 perform a gripping motion.

While the present disclosure has been described in detail with reference to the preferred exemplary embodiments, it is to be noted that the invention is not limited to the above-described specific exemplary embodiments, and many variations which do not depart from the essential spirit of the present disclosure are also included within the scope of the present disclosure. For example, an X-Y stage can be given as one example of an apparatus capable of driving a flat plate-like contact body in an optional direction on a plane face.

### Examples and Comparison Examples

Although the present disclosure will be described further in detail with examples and comparison examples, the invention is not limited to the below-described examples and is applicable in various ways without departing from the scope of the present disclosure. In each of the examples and comparison examples described below, a contact body included in a vibration type actuator is taken as an example. However, the invention is not limited thereto, and the present disclosure can also be applied to another friction material.

### (Manufacturing Method of Sintered Body According to Example 1)

In Example 1, mixed powder made of SUS 410L powder mixed with 1 wt % or less of a predetermined amount of carbon powder was used as stainless steel raw-material powder. The SUS 410L powder is a standardized product compliant with Japanese Industrial Standards (JIS), (Carbon (C): 0.15 wt % or less, Chromium (Cr): 11.5 wt % to 13.0 wt %, Silicon (Si): 0.5 wt % or less, Manganese (Mn): 1 wt % or less, Phosphorus (P): 0.04 wt % or less, Sulfur(S): 0.03 wt % or less, and Iron (Fe): residuals). The raw-material powder was put into a cavity-shaped ultra-hard metal mold having a size of 40 mm×5 mm, and the raw-material powder was pressurized and molded into a predetermined board thickness. The acquired molded body was sintered for 30 minutes at a temperature of 1220° C. Thereafter, a sintered body was manufactured by rapidly cooling the molded body by supplying nitrogen gas.

### (Manufacturing Method of Sintered Body According to Example 2)

In Example 2, a sintered body was manufactured in a manner similar to Example 1, except that the sintering process was executed at a sintering temperature changed to 1150° C.

### (Manufacturing Method of Sintered Body According to Example 3)

In Example 3, a sintered body was manufactured in a manner similar to Example 1, except that the sintering process was executed at a sintering temperature changed to 1100° C., the sintered body was immersed in liquid nitrogen for 30 minutes through a sub-zero treatment, and a thermal treatment was executed for 30 minutes at a temperature of 1220° C. After the thermal treatment, the sintered body was rapidly cooled with nitrogen gas.

### (Manufacturing Method of Sintered Body According to Example 4)

In Example 4, a sintered body was manufactured in a manner similar to Example 3, except that a temperature for the thermal treatment was changed to 1150° C.

### (Manufacturing Method of Sintered Body According to Example 5)

In Example 5, a sintered body was manufactured in a manner similar to Example 3, except that a temperature for the thermal treatment was changed to 1260° C.

### (Manufacturing Method of Sintered Body According to Example 6)

In Example 6, a sintered body was manufactured in a manner similar to Example 1, except that the sintering process was executed at a sintering temperature changed to 1240° C.

### (Manufacturing Method of Sintered Body According to Example 7)

In Example 7, a sintered body was manufactured in a manner similar to Example 1, except that the sintered body was immersed in liquid nitrogen for 1 second through the sub-zero treatment after the sintering process was executed.

### (Manufacturing Method of Sintered Body According to Comparison Example 1)

In Comparison Example 1, a sintered body was manufactured in a manner similar to Example 1, except that SUS 304 powder that is not mixed with carbon powder was used as the stainless steel raw-material powder. The SUS 304 powder is a standardized product compliant with JIS, (C: 0.08 wt % or less, Cr: 18 wt % to 20 wt %, Nickel (Ni): 8 wt % to 10.5 wt %, Si: 1 wt % or less, Mn: 2 wt % or less, P: 0.045 wt % or less, S: 0.03 wt % or less, and Iron (Fe) for the rest).

### (Manufacturing Method of Sintered Body According to Comparison Example 2)

In Comparison Example 2, a sintered body was manufactured in a manner similar to Comparison Example 1, except that a sintering temperature was changed to 1200° C.

### (Manufacturing Method of Sintered Body According to Comparison Example 3)

In Comparison Example 3, a sintered body was manufactured in a manner similar to Example 1, except that the sintering process was executed at a sintering temperature changed to 1100° C., and the sintered body was immersed in liquid nitrogen for 30 minutes through the sub-zero treatment.

### (Manufacturing Method of Sintered Body According to Comparison Example 4)

In Comparison Example 4, a sintered body was manufactured in a manner similar to Comparison Example 3, except that the thermal treatment was executed for 30 minutes after the sub-zero treatment was executed.

### (Manufacturing Method of Sintered Body According to Comparison Example 5)

In Comparison Example 5, a sintered body was manufactured in a manner similar to Comparison Example 3, except that a sintering temperature was changed to 1150° C.

### (Manufacturing Method of Sintered Body According to Comparison Example 6)

In Comparison Example 6, a sintered body was manufactured in a manner similar to Example 1, except that the sintered body was immersed in liquid nitrogen for 1 minute through the sub-zero treatment after the sintering process was executed.

In order to remove flashes from sintered bodies, barrel polishing was executed on the sintered bodies acquired through the above-described manufacturing methods according to Examples 1 to 7 and Comparison Examples 1 to 6. Manufacturing conditions applied to respective Examples and Comparison examples are shown in Table 1.

Before a next process was executed, density, hardness, and a ratio of the martensite phase were measured, and a crystal phase was identified by X-ray diffraction. The density was measured by the Archimedes method. The relative density was then acquired by dividing the measured density by theoretical density, and porosity rate was calculated by subtracting the relative density from 100%. The hardness was measured by using a Micro Vickers Hardness Tester HMV-2, a product of Shimadzu Corporation. Specifically, an area where a pore is not formed on a surface of the sintered body was specified as a measurement point, and hardness was measured with a pressing load of 0.98 N.

A ratio of the martensite phase to the sintered body was measured through a magnetic guidance method by using a FISCHER SCOPE, a product of FISCHER INSTRUMENTS K.K. As described above, because the ratio acquired as a measured value is based on a total volume including pores, the measured value is converted to a value based on a volume excluding the porosity rate. An X-ray diffractometer Ultima 4, a product of Rigaku Corporation, was used for X-ray diffraction measurement. Copper (Cu) was used as a target, and X-ray diffraction measurement was executed at an angle 2θ of 35° to 60°, with an output of 40 kV-40 mA.

Only a α′ structure-derived peak indicating a martensite phase and a γ structure-derived peak indicating an austenite phase were detected from the acquired spectrum. Through the above detection, it was confirmed that the sintered body was made of the martensite phase and the austenite phase. Thus, a volume ratio of the austenite phase is acquired by subtracting a volume ratio of the martensite phase from 100%. Evaluation results of the sintered bodies in the examples and comparison examples are illustrated in Table 1.

TABLE 1
Manufacturing Conditions and Properties of Sintered
Bodies in Examples and Comparison Examples

| | | Treatment Condition of Each Process | | | |
|---|---|---|---|---|---|
| | | | | | Temperature of |
| | | Sintering | Sub-Zero | | Thermal |
| | | Temperature | Treatment | | Treatment |
| | Material | (° C.) | Time | | (° C.) |
| Example 1 | SUS410L, Carbon | 1220 | — | | — |
| Example 2 | SUS410L, Carbon | 1150 | — | | — |
| Example 3 | SUS410L, Carbon | 1100 | 30 | min | 1220 |
| Example 4 | SUS410L, Carbon | 1100 | 30 | min | 1150 |
| Example 5 | SUS410L, Carbon | 1100 | 30 | min | 1260 |
| Example 6 | SUS410L, Carbon | 1240 | — | | — |
| Example 7 | SUS410L, Carbon | 1220 | 1 | sec | — |
| Comparison Example 1 | SUS304 | 1220 | — | | — |
| Comparison Example 2 | SUS304 | 1200 | — | | — |
| Comparison Example 3 | SUS410L, Carbon | 1100 | 30 | min | — |
| Comparison Example 4 | SUS410L, Carbon | 1100 | 30 | min | 1100 |
| Comparison Example 5 | SUS410L, Carbon | 1150 | 30 | min | — |
| Comparison Example 6 | SUS410L, Carbon | 1220 | 1 | min | — |

| | | | | Content Rate of | Content Rate of |
|---|---|---|---|---|---|
| | | | Vickers | Martensite | Austenite |
| | Density | Porosity | Hardness | Phase | Phase |
| | (g/cm3) | (%) | (HV0.1) | (%) | (%) |
| Example 1 | 6.63 | 14.1 | 560 | 10.8 | 89.2 |
| Example 2 | 6.61 | 14.3 | 457 | 12.0 | 88.0 |
| Example 3 | 6.73 | 12.8 | 412 | 6.5 | 93.5 |
| Example 4 | 6.76 | 12.5 | 475 | 3.9 | 96.1 |
| Example 5 | 6.73 | 12.8 | 434 | 5.7 | 94.3 |
| Example 6 | 6.84 | 11.4 | 449 | 17.6 | 82.4 |
| Example 7 | 6.80 | 12.3 | 508 | 24.6 | 75.4 |
| Comparison Example 1 | 6.52 | 17.8 | 255 | 0.0 | 100.0 |
| Comparison Example 2 | 6.51 | 17.9 | 274 | 0.0 | 100.0 |
| Comparison Example 3 | 6.62 | 14.3 | 850 | 39.3 | 60.7 |
| Comparison Example 4 | 6.74 | 12.7 | 648 | 26.2 | 73.8 |
| Comparison Example 5 | 6.70 | 13.2 | 850 | 40.5 | 59.5 |
| Comparison Example 6 | 6.81 | 11.8 | 615 | 35.0 | 65.0 |

Because warpage caused by sintering had occurred in the sintered body, polishing was executed by using a polishing sheet #1200 coated with silicon carbide (SiC) abrasive grains until the warpage became 0.1 mm or less. Thereafter, an ion nitriding treatment was executed. Specifically, in a chamber where nitrogen gas was introduced, glow discharge was generated under a predetermined pressure, and a nitride layer was formed by making nitrogen ions collide with a surface of the sample (sintered body).

Next an impregnation treatment of silicone-group resin was executed in order to enhance frictional force under the high-humidity environment. The sintered body placed in a metallic mesh basket was put into a vacuum chamber, and the inner space of the lidded vacuum chamber was depressurized to a pressure of 1 kPa or less. After depressurization, an impregnating agent sufficient for immersing the metallic mesh basket was put into the vacuum chamber through a pipe connected to the vacuum chamber. Thereafter, the vacuum chamber was pressurized. When the pressure was increased to 0.5 MPa, the vacuum chamber was left for 10 minutes. The vacuum chamber was then opened to the atmosphere, and the sample was taken out from the vacuum chamber. After the surface of the sintered body was wiped with a waste cloth, the sintered body was put into and left in an oven at a temperature of 100° C. or more and 150° C. or less in order to harden the impregnated resin.

Lastly, in order to reduce the surface roughness, lap polishing was executed for 10 minutes by using 3 μm diamond abrasive grains while applying a load of 600 grams for each of the sintered body.

After the process was completed, surface observation, measurement of surface hardness, and surface destruction testing for checking the abrasion resistance were executed.

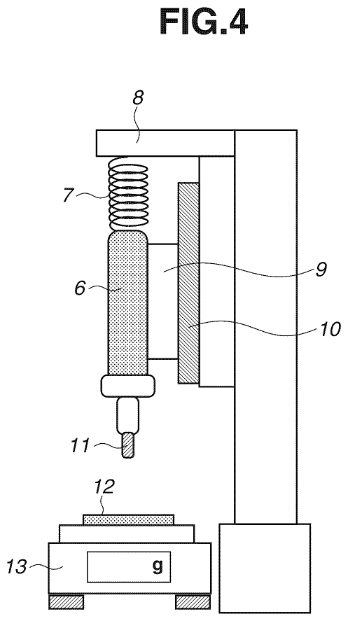

Through the surface observation, presence or absence of defect was checked visually and microscopically. The surface hardness was measured by the same method as that employed for the evaluation executed after the sintering process. The surface destruction testing was executed by using an evaluation device illustrated in FIG. 4. By using an ultrasonic disc cutter manufactured by Honda Electronics Co., Ltd., ultrasonic vibration was applied to the sintered body for 1 minute at a frequency of 40 kHz in a contact state where a load of 150 grams was applied to the surface of the sample (sintered body).

An ultrasonic cutter 6 is fixed to a fixture 9, and is also joined to an upper face portion 8 via a spring. The fixture 9 is joined to a movable linear guide 10. A rod 11 having a spherical-shape leading end having a radius of 2 mm, which is made of SUS 420J2, is attached to the ultrasonic cutter 6. The leading end of the rod 11 is brought into contact with a sample 12 by the linear guide 10. The sample 12 is placed on an electronic balance 13, and a contact load is adjusted to 150 grams on the electronic balance 13. In this way, a dent mark formed on the surface of the sample was observed, and a depth of the dent mark was measured.

A depth of the dent mark was measured by a scanning white light interference microscope, a product of Hitachi High-Tech Science Corporation, and a depth of the deepest portion of the dent mark was evaluated as a depth of the dent mark. Evaluation results of respective examples and comparison examples are illustrated in Table 2.

After the above-described evaluation was executed, a thickness of the nitride layer, hardness of the interior portion, and a content of the martensite phase in the interior portion were measured. When a thickness of the nitride layer was measured, a sample was roughly cut into half, and a cross-section face was polished and observed microscopically. The nitride layer formed on the surface layer was visually recognizable in a color different from a color of the interior portion. Thus, a distance between a boundary portion where the color was changed to another to the surface layer was measured from an observed image, and a thickness of the nitride layer was evaluated. These measurement results are shown in Table 2.

The maximum thickness of the nitride layer of all of the examples and comparison examples was 22 μm, and thus the interior portion was evaluated after the nitride layer was removed by polishing the surface by 0.1 mm. The hardness of the interior portion was measured through the same method as that employed for the measurement of the hardness of the sintered body and the nitride surface layer. With respect to the evaluation of the content of the austenite phase, a content of the martensite phase was measured through the same method as that employed for the evaluation of the sintered body, and a content of the austenite phase was calculated after that.

Results acquired in the respective examples and comparison examples are shown in Table 2. The hardness of the interior portion and the content of the austenite phase in the interior portion were not greatly changed from the results acquired for the sintered body, and change amounts thereof were equivalent to measurement deviations. Thus, it is possible to presume that compositional change arising in the interior portion through the nitriding treatment is fairly small.

As illustrated in the results in Table 2, in each of Examples 1 to 7, Vickers hardness of the interior portion was included within a range of 300 HV0.1 or more and 600 HV01 or less, and the content of the austenite phase in the interior portion was included within a range of 75 vol % or more and 99 vol % or less. In Examples 1 to 7, Vickers hardness of the surface layer corresponding to the nitride layer was high, i.e., 1000 HV0.1 or more, and a destruction mark was not observed in the destruction testing of the surface layer. Further, in Examples 1 to 7, a major defect was not particularly observed on the surface of the finished product.

On the other hand, in Comparison examples 1 and 2, it was confirmed that a dent mark was formed on a surface at a constant rate. Therefore, subsequent evaluations were not executed. It was presumed that a dent mark was formed when the barrel polishing process was executed after the sintering process, or when a component was brought into contact with another component or peripheral materials while the component was being transferred from one process to another process, because hardness thereof was not sufficient.

In Comparison examples 3 to 6, hardness of the interior portion was greater than 600 HV0.1, and a content of the austenite phase in the interior portion was less than 75 vol %. Although Vickers hardness of the surface was high, a deeply bored portion, i.e., a destruction mark, accompanied by cracks, was locally observed by the surface destruction test. In relation to the above situation, a depth of the dent mark formed by ultrasonic vibration was deep in comparison to the depth measured in Examples 1 to 7.

Based on the above-described results, it is confirmed that a friction material including a stainless steel sintered body having high surface hardness, high destruction strength, and excellent abrasion resistance can be provided by the friction materials according to the respective examples. In other words, it is possible to provide a friction material having high surface hardness, high destruction strength, and high abrasion resistance by controlling the Vickers hardness of the interior portion to be in a range of 300 HV0.1 or more and 600 HV0.1 or less, and the content of the austenite phase in the interior portion to be in a range of 75 vol % or more and 99 vol % or less.

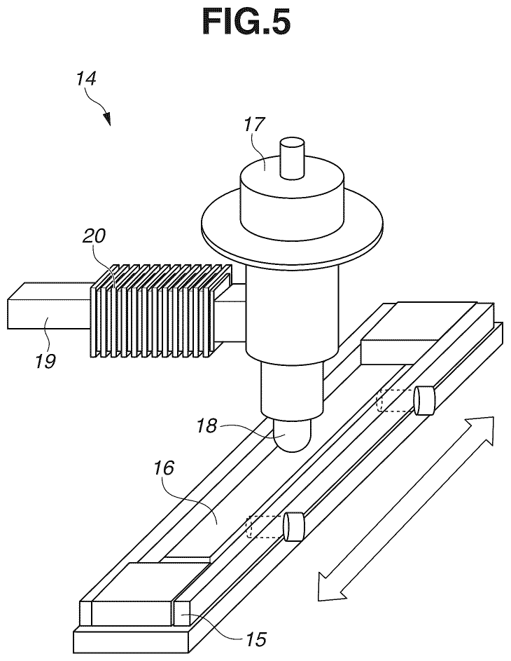

Further, frictional force was evaluated with respect to all of the Examples and Comparison examples except for Comparison examples 1 and 2. The frictional force was evaluated through a method as illustrated in FIG. 5 by using a friction/abrasion testing device, a product of Rhesca Co., Ltd. A friction material 16 fixed with screws was placed on a movable stage 15 and brought into contact with a pin member 18 in a state where a load was applied by a weight 17, and frictional force was measured by a load sensor 20 while driving the movable stage 15 back and forth within a range of 10 mm.

A round-shape bar made of stainless steel (SUS) 420J2, having a diameter of 2 mm, was used as the pin member 18. The pin member 18 was brought into contact with the friction material 16 in a state where an angle was adjusted with a level indicator so that an arm 19 was kept in a horizontal position. A weight having a mass of 150 g was used as the weight 17. First, as a preliminary sliding operation, a sliding operation was executed back and forth for 5000 times at a moving speed of 20 mm/s under the above-described condition. Thereafter frictional force in a dry state was measured at a moving speed of 1 mm/s. From among the measured values of the frictional force acquired from the range of 10 mm, an average value of the frictional force was calculated based on the measured values acquired from a range of 2 mm to 8 mm from a starting position, where the measured values were comparatively stable, and a friction coefficient was calculated based on the average value. The friction material and the pin member were then left in a constant temperature/humidity chamber at a temperature of 60° C. and a humidity of 90% for 20 hours. The friction material and the pin member were then taken out of the constant temperature/humidity chamber to be promptly set again. Then, the frictional force was measured under the same condition as that applied in the dry state, and the friction coefficient was calculated. As a result, it was confirmed that the friction material maintained a high friction coefficient of 0.4 in both of the above-described states.

TABLE 2
Testing Results and Analysis Results of Examples and Comparison Examples

| | | | Surface Layer Destruction Test | |
|---|---|---|---|---|
| | | Surface | | Depth of |
| | | Vickers | | Dent |
| | Surface | Hardness | Destruction | Mark |
| | Defect | (HV0.1) | Mark | (μm) |
| Example 1 | Not observed | 1385 | Not observed | 1.1 |
| Example 2 | Not observed | 1321 | Not observed | 1.3 |
| Example 3 | Not observed | 1366 | Not observed | 0.8 |
| Example 4 | Not observed | 1361 | Not observed | 1.0 |
| Example 5 | Not observed | 1333 | Not observed | 0.8 |
| Example 6 | Not observed | 1394 | Not observed | 1.1 |
| Example 7 | Not observed | 1280 | Not observed | 0.8 |
| Comparison Example 1 | Observed | — | — | — |
| Comparison Example 2 | Observed | — | — | — |
| Comparison Example 3 | Not observed | 1386 | Observed | 3.7 |
| Comparison Example 4 | Not observed | 1318 | Observed | 4.3 |
| Comparison Example 5 | Not observed | 1213 | Observed | 3.0 |
| Comparison Example 6 | Not observed | 1312 | Observed | 2.3 |

| | Analysis Result of Finished Product | | | |
|---|---|---|---|---|
| | | Interior Portion | | |
| | | | Content Rate of | Content Rate of |
| | Thickness of | Vickers | Martensite | Austenite |
| | Nitride Layer | Hardness | Phase | Phase |
| | (μm) | (HV0.1) | (%) | (%) |
| Example 1 | 7.0 | 554 | 11.2 | 88.8 |
| Example 2 | 11 | 422 | 12.8 | 87.2 |
| Example 3 | 22 | 399 | 6.5 | 93.5 |
| Example 4 | 13 | 446 | 4.3 | 95.7 |
| Example 5 | 5.0 | 436 | 5.9 | 94.1 |
| Example 6 | 6.0 | 454 | 18.4 | 81.6 |
| Example 7 | 16 | 539 | 24.9 | 75.1 |
| Comparison Example 1 | — | — | — | — |
| Comparison Example 2 | — | — | — | — |
| Comparison Example 3 | 15 | 793 | 37.8 | 62.2 |
| Comparison Example 4 | 14 | 604 | 27.0 | 73.0 |
| Comparison Example 5 | 6.0 | 811 | 38.9 | 61.1 |
| Comparison Example 6 | 10 | 603 | 35.9 | 64.1 |

According to the present disclosure, it is possible to provide a friction material having high abrasion resistance, capable of maintaining frictional force even under the high-humidity environment. Further, according to the present disclosure, it is possible to provide a vibration type actuator, an optical device, and an electronic device, which include friction materials having high abrasion resistance, capable of maintaining frictional force even under the high-humidity environment. Furthermore, according to the present disclosure, it is possible to provide a manufacturing method of a friction material having high abrasion resistance, capable of maintaining frictional force even under the high-humidity environment.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-205717, filed Dec. 5, 2023, which is hereby incorporated by reference herein in its entirety.

What is claimed is:

1. A friction material comprising:
a stainless steel group sintered body having pores,
wherein the stainless steel group sintered body includes a nitride layer and an interior portion, the nitride layer containing iron nitride and being present on a surface of the stainless steel group sintered body, the interior portion being present in an inner part of the stainless steel group sintered body,
wherein the interior portion includes an austenite phase and a martensite phase, a content of the austenite phase in the interior portion being 75 vol % or more and 99 vol % or less, and
wherein a Vickers hardness of the interior portion is 300 HV0.1 or more and 600 HV0.1 or less.

2. The friction material according to claim 1, wherein a resin is present in at least a part of inner parts of the pores.

3. The friction material according to claim 2, wherein the resin includes silicone group resin.

4. The friction material according to claim 1, wherein a porosity rate of the stainless steel group sintered body is 15% or less.

5. The friction material according to claim 1, wherein a content of chromium in the stainless steel group sintered body is 16 wt % or less.

6. The friction material according to claim 1, wherein the nitride layer includes, as the iron nitride, at least any one of:
an ε phase (Fe₂₋₃N),
a γ′ phase (Fe₄N), or
a mixed phase of the ε phase (Fe₂₋₃N) and the γ′ phase (Fe₄N).

7. The friction material according to claim 1, wherein a thickness of the nitride layer is 1.0 μm or more.

8. The friction material according to claim 1, wherein a Vickers hardness of the interior portion is 390 HV0.1 or more and 580 HV0.1 or less.

9. The friction material according to claim 1, wherein a content of the austenite phase in the interior portion is 75 vol % or more and 97 vol % or less.

10. A friction material comprising:
a stainless steel group sintered body having pores,
wherein the stainless steel group sintered body includes a nitride layer and an interior portion, the nitride layer containing iron nitride, which is present on a surface of the stainless steel group sintered body, the interior portion being present in an inner part of the stainless steel group sintered body,
wherein the interior portion contains an austenite phase and a martensite phase, a content of the austenite phase in the interior portion being 1.0 vol % or more and 25 vol % or less, and
wherein a Vickers hardness of the interior portion is 300 HV0.1 or more and 600 HV0.1 or less.

11. A vibration type actuator comprising:
a vibration body including an electric-mechanical energy conversion element and an elastic body; and
a contact body that includes a friction material including a stainless steel group sintered body having pores,
wherein the stainless steel group sintered body includes a nitride layer and an interior portion, the nitride layer containing iron nitride and being present on a surface of the stainless steel group sintered body, the interior portion being present in an inner part of the stainless steel group sintered body,
wherein the interior portion includes an austenite phase and a martensite phase, a content of the austenite phase in the interior portion being 75 vol % or more and 99 vol % or less,
wherein a Vickers hardness of the interior portion is 300 HV0.1 or more and 600 HV0.1 or less,
wherein the contact body is in contact with a surface of the elastic body at a contact face, and
wherein the vibration body and the contact body are relatively moved by a vibration generated by the vibration body.

12. An optical device comprising:
a vibration type actuator; and
at least any one of an optical element or an imaging element driven by the vibration type actuator,
wherein the vibration type actuator comprises a vibration body including an electric-mechanical energy conversion element and an elastic body and a contact body including a friction material including a stainless steel group sintered body having pores,
wherein the contact body is in contact with a surface of the elastic body at a contact face,
wherein the vibration body and the contact body included in the vibration type actuator are relatively moved by a vibration generated by the vibration body,
wherein the stainless steel group sintered body includes a nitride layer and an interior portion, the nitride layer containing iron nitride and being present on a surface of the stainless steel group sintered body, the interior portion being present in an inner part of the stainless steel group sintered body,
wherein the interior portion includes an austenite phase and a martensite phase, a content of the austenite phase in the interior portion being 75 vol % or more and 99 vol % or less, and
wherein a Vickers hardness of the interior portion is 300 HV0.1 or more and 600 HV0.1 or less.

13. An electronic device comprising:
members; and
a vibration type actuator for driving the members,
wherein the vibration type actuator comprises a vibration body including an electric-mechanical energy conversion element and an elastic body and a contact body including a friction material including a stainless steel group sintered body having pores,
wherein the contact body is in contact with a surface of the elastic body at a contact face,
wherein the vibration body and the contact body included in the vibration type actuator are relatively moved by a vibration generated by the vibration body,
wherein the stainless steel group sintered body includes a nitride layer and an interior portion, the nitride layer containing iron nitride and being present on a surface of the stainless steel group sintered body, the interior portion being present in an inner part of the stainless steel group sintered body,
wherein the interior portion includes an austenite phase and a martensite phase, a content of the austenite phase in the interior portion being 75 vol % or more and 99 vol % or less, and
wherein a Vickers hardness of the interior portion is 300 HV0.1 or more and 600 HV0.1 or less.

14. A manufacturing method of a friction material, the manufacturing method comprising:
acquiring a stainless steel group sintered body by sintering raw-material powder containing stainless steel powder, after the raw-material powder is pressurized and molded; and
executing a nitriding treatment process for forming a nitride layer on a surface of the stainless steel group sintered body,
wherein the stainless steel group sintered body has a nitride layer and an interior portion, the nitride layer containing iron nitride and being present on a surface of the stainless steel group sintered body, the interior portion being present in an inner part of the stainless steel group sintered body,
wherein the interior portion includes an austenite phase and a martensite phase, a content of the austenite phase in the interior portion being 75 vol % or more and 99 vol % or less, and
wherein a Vickers hardness of the interior portion is 300 HV0.1 or more and 600 HV0.1 or less.

15. A manufacturing method of a friction material, the manufacturing method comprising:
acquiring a stainless steel group sintered body by sintering raw-material powder containing stainless steel powder, after the raw-material powder is pressurized and molded; and
executing a nitriding treatment process for forming a nitride layer on a surface of the stainless steel group sintered body,
wherein the stainless steel group sintered body has a nitride layer and an interior portion, the nitride layer containing iron nitride and being present on a surface of the stainless steel group sintered body, the interior portion being present in an inner part of the stainless steel group sintered body,
wherein the interior portion includes an austenite phase and a martensite phase, a content of the martensite phase in the interior portion being 1.0 vol % or more and 25 vol % or less, and
wherein a Vickers hardness of the interior portion is 300 HV0.1 or more and 600 HV0.1 or less.
